(19) United States
(12) Patent Application Publication
(10) Pub. No.: US 2026/0056789 A1
(43) Pub. Date: Feb. 26, 2026

(54) DYNAMIC LOCATION SELECTION FOR FUNCTION INVOCATION

(71) Applicant: Red Hat, Inc., Raleigh, NC (US)

(72) Inventors: Leonardo Rossetti, Sao Paulo (BR); Leigh Griffin, Waterford (IE)

(21) Appl. No.: 18/813,982

(22) Filed: Aug. 23, 2024

(51) Int. Cl. G06F 9/50

(52) U.S. Cl. CPC G06F 9/5027

(57) ABSTRACT

A first computing device determines that an asynchronous function of an executing process executing on a second computing device is to be invoked. The first computing device determines that a real-time condition of the second computing device is met. In response to determining that the real-time condition of the second computing device is met, the first computing device selects an execution computing device that is a different computing device than the second computing device. The first computing device causes the asynchronous function to be executed on the execution computing device.

### BACKGROUND

Computer applications are typically written in programming languages that allow sets of instructions that provide a desired functionality and that will be executed repeatedly during the lifespan of the application to be defined in a single function that can be invoked from any number of locations in the application.

### SUMMARY

The examples disclosed herein implement dynamic location selection for function invocation.

In one example a method is provided. The method includes determining, by a first computing device, that an asynchronous function of an executing process executing on a second computing device is to be invoked. The method further includes determining, by the first computing device, that a real-time condition of the second computing device is met The method further includes, in response to determining that the real-time condition of the second computing device is met, selecting an execution computing device that is a different computing device than the second computing device. The method further includes causing the asynchronous function to be executed on the execution computing device.

In another example a computing device is provided. The computing device includes a memory and one or more processor devices coupled to the memory to determine that an asynchronous function of an executing process executing on a second computing device is to be invoked. The one or more processor devices are further to determine that a real-time condition of the second computing device is met. The one or more processor devices are further to, in response to determining that the real-time condition of the second computing device is met, select an execution computing device that is a different computing device than the second computing device. The one or more processor devices are further to cause the asynchronous function to be executed on the execution computing device.

In another example a non-transitory computer-readable storage medium is provided. The non-transitory computer-readable storage medium includes executable instructions to cause one or more processor devices to determine that an asynchronous function of an executing process executing on a second computing device is to be invoked. The instructions are further to cause the one or more processor devices to determine that a real-time condition of the second computing device is met. The instructions are further to cause the one or more processor devices to, in response to determining that the real-time condition of the second computing device is met, select an execution computing device that is a different computing device than the second computing device. The instructions are further to cause the one or more processor devices to cause the asynchronous function to be executed on the execution computing device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which dynamic location selection for function invocation can be practiced according to some implementations;

FIG. 2 is flowchart of a method for dynamic location selection for function invocation according to some implementations;

FIG. 3 is a simplified block diagram of the environment illustrated in FIG. 1 in which dynamic location selection for function invocation can be practiced according to some implementations; and

FIG. 4 is a block diagram of a computing device suitable for implementing examples disclosed herein according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Computer applications are typically written in programming languages that allow sets of instructions that provide a desired functionality and that will be executed repeatedly during the lifespan of the application to be defined in a single function that can be invoked from any number of locations in the application. A function may be defined by a function name, a parameter list that defines input and/or output parameters, and a series of instructions that implement a desired task upon invocation of the function. A compiler or interpreter recognizes a function because the programming instructions that declare and define the function conform to a particular syntax associated with the corresponding programming language that defines the rules for declaring and defining a function.

An application may utilize synchronous functions and asynchronous functions. When a synchronous function is invoked (e.g., called), the application flow pauses until the function finishes. The application flow begins again at the instruction that follows the function call. When an asynchronous function is invoked, the application flow immediately continues on to the instruction that follows the function call even though the function has not finished executing.

Asynchronous functions may be implemented for tasks that may take some time and for which the results of the function are not needed immediately, or at all, in order to perform other tasks. For example, if a computer application desired to periodically generate and send a report, the logic necessary for generating and sending the report may be coded into an asynchronous function. A timer may be set by the computer application, and upon expiration, the computer application may invoke the asynchronous function and immediately continue performing other processing because the generation and sending of the report will not interfere with additional processing of the computer application.

Certain types of computing devices are designed to have limited resources, such as limited processing power, limited memory, limited storage, and the like because such devices typically implement a specialized function that may ordinarily require only limited resources. Such devices may also be battery powered, and limiting resources can reduce power consumption. Edge computing devices and/or Internet-of-Things (IoT) devices are examples of such resource-constrained computing devices. Examples of such devices include temperature sensors, acoustic and noise sensors, gyroscope sensors, actuators, moisture sensors, light sensors, motion sensors, chemical sensors, water level sensors, presence and proximity sensors, and image sensors.

Computing devices may become resource constrained even when not designed to be resource constrained due to applications growing over time, or poorly designed applications, or the like. In either scenario, an executing application, referred to herein as an executing process, may need to cause a desired task to be performed, and such task may be implemented via an invocable asynchronous function. Because the asynchronous function can be invoked and can execute without halting the application, there are certain situations where it may be desirable to cause the invocable asynchronous function to be invoked on a different computing device than the computing device executing the computer application that defines the asynchronous function. For example, the computing device executing the computer application may be very low on memory, and invoking the asynchronous function on the computing device may cause a shortage of memory and severely bog the computing device down, or even cause the computing device to freeze. Alternatively, the computer application may need to, on a particular schedule, such as every 100 milliseconds, perform a different task, and invoking the function under the current circumstances, such as lack of available memory or processor, will prevent the application from performing the different task in accordance with the schedule.

The examples disclosed herein implement dynamic location selection for function invocation. A first computing device determines that a function of an executing process that is executing on a second computing device is to be invoked. The first computing device determines that a first real-time condition of the second computing device is met, such as, by way of non-limiting example, that an amount of available memory is below a predetermined threshold or that processor utilization is above a predetermined threshold. The first computing device causes the function to be executed on a computing device other than the second computing device in response to determining that the first real-time condition is met. In this manner, a computing device that has, for example, constrained resources at a particular instance in time can dynamically decide to cause the invocation of a task on an external computing device rather than on the computing device.

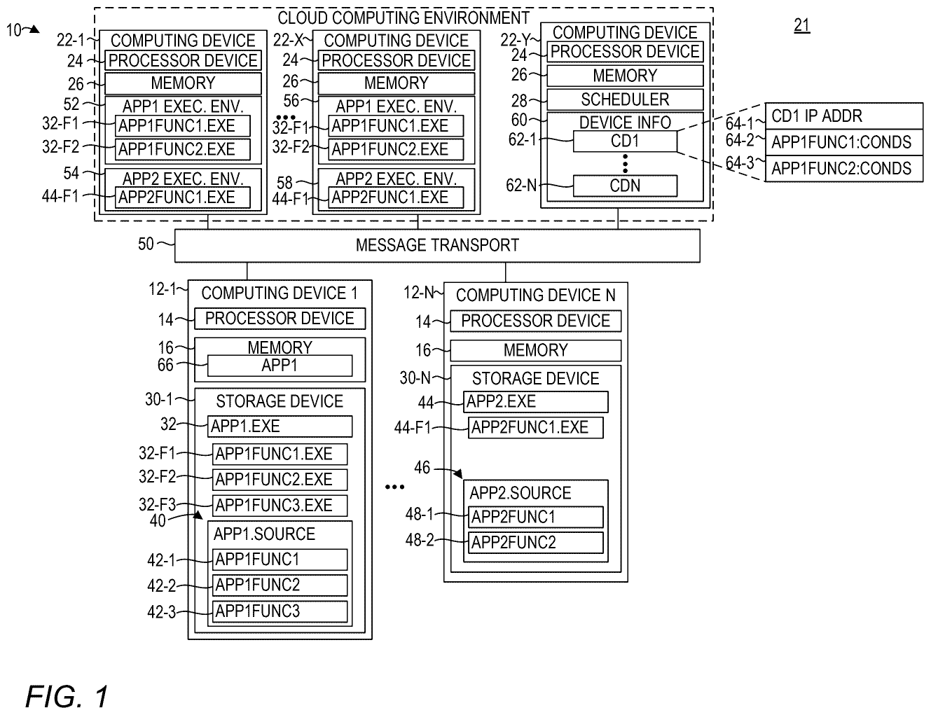

FIG. 1 is a block diagram of an environment 10 in which dynamic location selection for function invocation can be practiced according to some implementations. The environment 10 includes a plurality of computing devices 12-1-12-N (generally, computing devices 12), each of which includes a processor device 14 and a memory 16. In some implementations, the computing devices 12 may comprise resource-constrained edge or IoT computing devices, such as intelligent sensors, actuators, or the like. The computing devices 12 may, in some examples, be battery powered.

The computing devices 12 are communicatively coupled via one or more networks to a computer cluster 21 that includes a plurality of computing devices 22-1-22-X, 22-Y (generally, computing devices 22). The computer cluster 21 may comprise, for example, one or more private or public cloud computing environments. The computing devices 22 include processor devices 24 and memories 26. The computing devices 22 may be bare metal machines (i.e., physical computing devices), virtual machines implemented on bare metal machines (in which case the processor devices 24 are virtual CPUs), or a combination of both bare metal machines and virtual machines. A scheduler 28 executing on the computing device 22-Y (e.g., first computing device) may cause processes to be initiated on one or more of the computing devices 22. The scheduler 28 may select a particular computing device 22 on which to cause a process to be initiated based on some criterion or criteria, such as the current load of the computing devices 22.

The computing device 12-1 includes a storage device 30-1 on which an application executable 32 and function executables 32-F1, 32-F2 and 32-F3 (sometimes referred to herein as functions 32) are stored. The application executable 32 and function executables 32-F1, 32-F2 and 32-F3 are binary or interpretable instructions generated from a same codebase that includes a complete set of application source code files 40. The source code files 40 define an application that includes a plurality of functions 42-1-42-3 (generally, functions 42) via programming instructions that comply with a programming language syntax, such as C, Java, or the like. Some of the functions 42 may be asynchronous functions. For purposes of illustration it will be assumed that the functions 42-1, 42-2 and 42-3 are asynchronous functions. When, for example, the asynchronous function 42-1 is invoked by an instruction in the source code files 40, the application flow immediately continues on to the instruction that follows the function invocation to the asynchronous function 42-1 even though the asynchronous function 42-1 has not finished executing.

The source code files 40 are written in a manner that the functions 42-1, 42-2 and 42-3, when compiled or otherwise translated into executables, are stored in separate executable files. In this example, the functions 42-1, 42-2 and 42-3 are compiled and stored as the function executables 32-F1, 32-F2 and 32-F3. Thus, the function executable 32-F1, when run in a memory of a computing device, implements the logic contained in the source code instructions of the asynchronous function 42-1. The function executable 32-F2, when run in a memory of a computing device, implements the logic contained in the source code instructions of the function 42-2, and the function executable 32-F3, when run in a memory of a computing device, implements the logic contained in the source code instructions of the function 42-3.

The computing device 12-N includes a storage device 30-N on which an application executable 44 and a function executable 44-F1 (sometimes referred to herein as the functions 44-F1) is stored. The application executable 44 and the function executable 44-F1 are binary or interpretable instructions generated from a same codebase that includes a complete set of application source code files 46. The source code files 46 define an application that includes a plurality of functions 48-1 and 48-2 (generally, functions 48) via programming instructions that comply with a programming language syntax, such as C, Java, or the like. Some of the functions 48 may be asynchronous functions. For purposes of illustration, it will be assumed that the function 48-1 is an asynchronous function and the function 48-2 is not an asynchronous function. The application executable 44 may implement similar functionality to the application executable 32, or different functionality.

The source code files 46 are written in a manner that the function 48-1, when compiled or otherwise translated into an executable, is stored in a separate executable file. In this example, the function 48-1 is compiled and stored as the function executable 44-F1. Thus, the function executable 44-F1, when run in a memory of a computing device, implements the logic contained in the source code instructions of the function 48-1. In this example, the function 48-2 is not an asynchronous function, and the executable code that implements the function 48-2 may be part of the application executable 44.

The computing devices 22 and 12 can communicate with one another via one or more networks, and may implement a structured communication mechanism, such as, by way of non-limiting example, a standardized application programming interface (API), or a message transport 50, such as, by way of non-limiting example, a message queue, a message bus, or a publish-subscribe message protocol, such as MQTT or the like, that facilitates communications between processes.

The computing device 22-1 includes an application execution environment 52 that is operable to run, on demand, the asynchronous functions 32-F1 and 32-F2. The application execution environment 52 may comprise whatever software necessary to run the asynchronous functions 32-F1 and 32-F2, such as a Java virtual machine, particular library packages, and the like. The application execution environment 52 includes copies of the asynchronous functions 32-F1 and 32-F2. The application execution environment 52 may include a copy of the application executable 32 if the asynchronous functions 32-F1 and 32-F2 cannot be run separately from the application executable 32. In some implementations, when executing the asynchronous functions 32-F1 or 32-F2, the computing device 22-1 may containerize the asynchronous functions 32-F1 or 32-F2 and run the asynchronous functions 32-F1 or 32-F2 in containers. In some implementations, the computing device 22-1 may run the asynchronous functions 32-F1 or 32-F2 in a trusted execution environment.

The computing device 22-1 also includes an application execution environment 54 that is operable to run, on demand, the asynchronous function 44-F1. Again, the application execution environment 54 may comprise whatever software necessary to run the asynchronous function 44-F1, and may even include the application executable 44 if the asynchronous function 44-F1 cannot be run separately from the application executable 44.

The computing device 22-X includes an application execution environment 56 that is operable to run the asynchronous functions 32-F1 and 32-F2, and an application execution environment 58 that is operable to run the asynchronous function 44-F1. Although not illustrated, the computing device 22-Y may similarly include execution environments suitable for running the asynchronous functions 32-F1, 32-F2, and 44-F1.

With this background, an example of dynamic location selection for function invocation will be discussed. In this implementation, the scheduler 28 maintains device information 60 that includes a plurality of entries 62-1-62-N, each of which corresponds to one of the computing devices 12-1-12-N. The entries 62 may identify the corresponding computing device 12, and may include, for example, address information, such as Internet Protocol (IP) address information of the corresponding computing device 12 and asynchronous function identifiers that identify asynchronous functions that may be executed on computing devices other than the corresponding computing device 12.

As an example, the entry 62-1 corresponds to the computing device 12-1. The entry 62-1 includes an IP address field 64-1 that contains an IP address of the computing device 12-1, and an asynchronous function field 64-2 that identifies the asynchronous function 32-F1 and identifies one or more conditions. When the asynchronous function 32-F1 is to be invoked, the scheduler 28 uses the one or more conditions to determine whether the asynchronous function 32-F1 should be invoked on the computing device 12-1 or should be offloaded and invoked on another computing device, such as a computing device 22. The entry 62-1 includes an asynchronous function field 64-3 that identifies the asynchronous function 32-F2 and identifies one or more conditions. When the asynchronous function 32-F2 is to be invoked, the scheduler 28 uses the one or more conditions to determine whether the asynchronous function 32-F2 should be invoked on the computing device 12-1 or should be offloaded and invoked on another computing device, such as a computing device 22. Note that there is no entry for the asynchronous function 32-F3 because the asynchronous function 32-F3 is an asynchronous function that had not been designated as being executable on a computing device other than the computing device 12-1. This may occur, for example, because the task implemented by the asynchronous function 32-F3 involves sensitive information. Thus, the asynchronous functions 32-F1 and 32-F2 are in a set of asynchronous functions that are identified as being executable on a computing device other than the computing device 12-1, and the asynchronous function 32-F3 is in a set of asynchronous functions that are identified as being executable only on the computing device 12-1.

For purposes of illustration, assume that an executing process 66 is initiated on the computing device 12-1 (e.g., second computing device) from the application executable 32. The executing process 66 connects to the message transport 50. The executing process 66 at some point determines that the asynchronous function 32-F1 of the executing process 66 is to be invoked to perform some task. The executing process 66 communicates to the scheduler 28 a need to invoke the asynchronous function 32-F1 of the executing process 66. In one implementation, the executing process 66 may publish a function invocation message on the message transport 50 that identifies the asynchronous function 32-F1 of the executing process 66. The scheduler 28 subscribes to function invocation messages, and thus, the message is inserted into a queue associated with the scheduler 28. In another implementation, the executing process 66 may invoke an API of the scheduler 28 to inform the scheduler 28 of the need to invoke the asynchronous function 32-F1. A parameter in the API invocation may contain an identifier of the asynchronous function 32-F1 of the executing process 66. If the asynchronous function 32-F1 requires input parameters, the executing process 66 may include the input parameters in the notification to the scheduler 28.

The scheduler 28 periodically, intermittently, or in response to some event, obtains real-time conditions of the computing devices 12. In this example, in response to being notified that the asynchronous function 32-F1 is to be invoked, the scheduler 28 requests, from the computing device 12-1, real-time resource utilization values that quantify real-time resource utilization of the computing device 12-1. The term “real-time” as used herein means substantially concurrently, such as within 100 milliseconds, 400 milliseconds, one second, or the like. The real-time resource utilization may comprise, by way of non-limiting example, memory utilization, processor device utilization, storage utilization, or the like. In some implementations, the computing device 12-1 may obtain the real-time resource utilization values prior to notifying the scheduler 28 that the asynchronous function 32-F1 is to be invoked and provide the real-time resource utilization values to the scheduler 28 along with the notification.

The scheduler 28 accesses the entry 62 that corresponds to the asynchronous function 32-F1, in this example, the entry 62-1. The scheduler 28 accesses the asynchronous function field 64-2 that identifies the asynchronous function 32-F1 and identifies the one or more conditions. The scheduler 28 determines whether the one or more conditions are met based on the real-time resource utilization values. For example, a condition may be that if less than 400 megabytes (MB) of memory is available on the computing device 12-1, the asynchronous function 32-F1 should be executed on a computing device other than the computing device 12-1. In another example, a condition may be that if processor utilization is currently over 75%, the asynchronous function 32-F1 should be executed on a computing device other than the computing device 12-1. In another example, a condition may be that if a real-time battery level of the computing device 12-1 is below a predetermined battery level threshold, the asynchronous function 32-F1 should be executed on a computing device other than the computing device 12-1.

In this example, a condition is that if less than 400 megabytes (MB) of memory is available on the computing device 12-1, the asynchronous function 32-F1 should be executed on a computing device other than the computing device 12-1. The scheduler 28 determines, based on a real-time resource utilization value that quantifies the real-time memory utilization of the computing device 12-1, that the real-time resource utilization value is below 400 MB, and is thus a non-preferred value and that the real-time condition of the second computing device 12-1 is met. In response to determining that the real-time condition of the computing device 12-1 is met, the scheduler 28 selects an execution computing device that is a different computing device than the computing device 12-1 and causes the asynchronous function 32-F1 to be executed on the execution computing device in lieu of being executed on the computing device 12-1.

In one implementation, prior to selecting an execution computing device, the scheduler 28 may obtain, from each of the plurality of computing devices 22-1-22-X (e.g., “third computing devices”), real-time resource utilization values that quantify real-time resource utilization of the plurality of computing devices 22-1-22-X. For example, the scheduler 28 may obtain a current processor utilization of each of the computing devices 22-1-22-X, a current memory utilization, a current queue depth for queued tasks, or the like. Based on the real-time resource utilization values, the scheduler 28 selects one of the computing devices 22-1-22-X as an execution computing device, and causes the asynchronous function 32-F1 to be executed on the selected execution computing device. In this example, because the computing device 22-1 has more memory and processor resources available than the computing device 22-X, the scheduler 28 selects the computing device 22-1 as the execution computing device.

The scheduler 28 may cause the asynchronous function 32-F1 to be executed on the selected execution computing device by sending instructions to the selected execution computing device to invoke the asynchronous function. For example, the scheduler 28 may publish a message having a particular message type on the message transport 50 that identifies the computing device 22-1 and the asynchronous function 32-F1 and contains instructions to the computing device 22-1 to invoke the asynchronous function 32-F1.

The computing device 22-1 initiates and runs the asynchronous function 32-F1. After completion of the execution of the asynchronous function 32-F1, output variables, if any, may be passed to the process 66 via, for example, the message transport 50.

Again, as discussed above, the computing device 22-Y may also be configured similarly to the computing devices 22-1-22-X and may determine that, in view of the real-time resource utilization values of the computing devices 22-1-22-X and the real-time resource utilization values of the computing device 22-Y, that the computing device 22-Y should be the execution computing device. The computing device 22-Y may then invoke the asynchronous function 32-F1.

Moreover, in some implementations, the computing devices 12 may be configured to be operable to invoke asynchronous functions in the manner described above with regard to the computing devices 22, and the scheduler 28 may select a computing device 12 as the execution computing device.

For purposes of illustration, assume that subsequent to the computing device 12-1 invoking the asynchronous function 32-F1, the executing process 66 again determines that the asynchronous function 32-F1 is to be invoked to perform a task. The executing process 66 communicates to the scheduler 28 a need to invoke the asynchronous function 32-F1.

The scheduler 28 obtains the real-time conditions of the computing device 12-1. The scheduler 28 accesses the entry 62 that corresponds to the asynchronous function 32-F1, in this example, the entry 62-1. The scheduler 28 accesses the asynchronous function field 64-2 that identifies the asynchronous function 32-F1 and identifies the one or more conditions. The scheduler 28 determines that no real-time condition is met. In response, the scheduler 28 causes the asynchronous function 32-F1 to be invoked by the computing device 12-1. For example, the scheduler 28 may send a message to the computing device 12-1 via the message transport 50 indicating that the computing device 12-1 is to invoke the asynchronous function 32-F1. In response, the computing device 12-1 invokes the asynchronous function 32-F1.

Because the scheduler 28 is a component of the computing device 22-Y, functionality implemented by the scheduler 28 may be attributed to the computing device 22-Y generally. Moreover, in examples where the scheduler 28 comprises software instructions that program the processor device 24 to carry out functionality discussed herein, functionality implemented by the scheduler 28 may be attributed herein to the processor device 24.

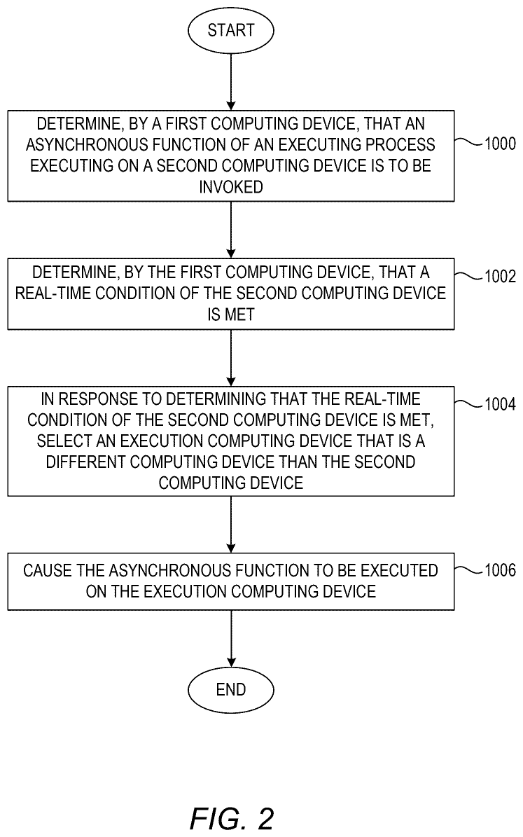

FIG. 2 is a flowchart of a method for dynamic location selection for function invocation according to some implementations. FIG. 2 will be discussed in conjunction with FIG. 1. The computing device 22-Y (e.g., a first computing device) determines that the asynchronous function 32-F1 of the executing process 66 executing on the computing device 12-1 (e.g., a second computing device) is to be invoked (FIG. 2, block 1000). The computing device 22-Y determines that a real-time condition of the computing device 12-1 is met (FIG. 2, block 1002). In response to determining that the real-time condition of the second computing device is met, the computing device 22-Y selects an execution computing device, in this example the computing device 22-1, that is a different computing device than the computing device 12-1 (FIG. 2, block 1004). The computing device 22-Y causes the asynchronous function 32-F1 to be executed on the computing device 22-1 (FIG. 2, block 1004).

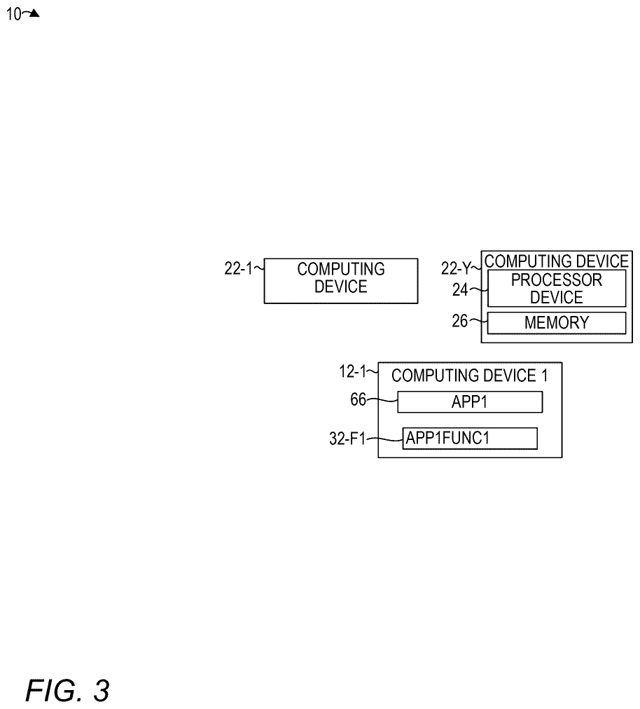

FIG. 3 is a simplified block diagram of the environment illustrated in FIG. 1 in which dynamic location selection for function invocation can be practiced according to some implementations. The environment 10 includes the computing device 22-Y, which in turn includes the memory 26 and the processor device 24 coupled to the memory 26. The processor device 24 determines that the asynchronous function 32-F1 of the executing process 66 executing on the computing device 12-1 is to be invoked. The processor device 24 determines that a real-time condition of the computing device 12-1 is met. In response to determining that the real-time condition of the computing device 12-1 is met, the processor device 24 selects the computing device 22-1 as the execution computing device that is a different computing device than the computing device 12-1. The processor device 24 causes the asynchronous function 32-F1 to be executed on the computing device 22-1.

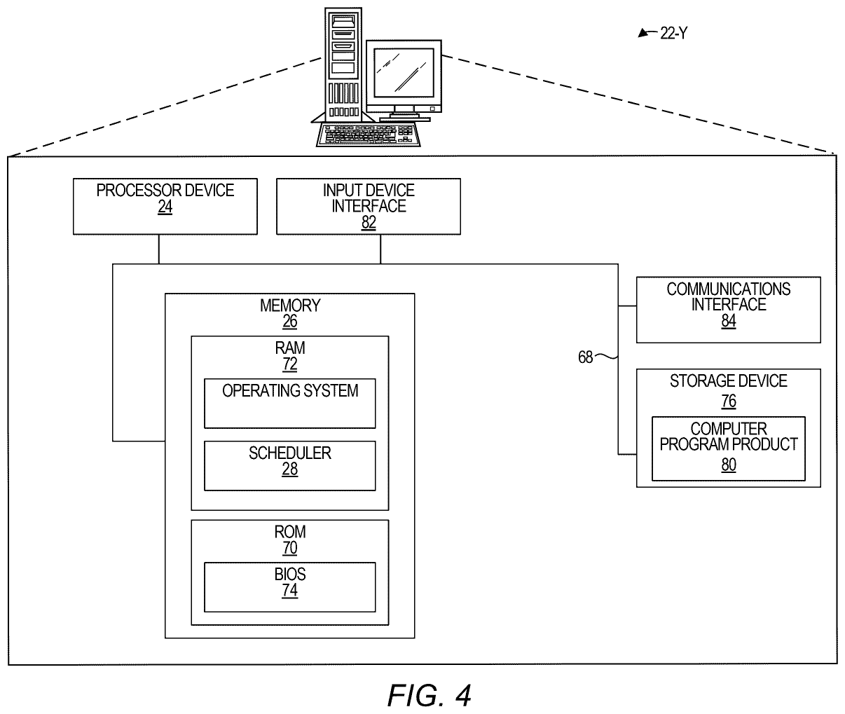

FIG. 4 is a block diagram of the computing device 22-Y suitable for implementing examples according to one example. The computing device 22-Y may comprise any computing or electronic device capable of including firmware, hardware, and/or executing software instructions to implement the functionality described herein, such as a computer server, a desktop computing device, or the like. The computing device 22-Y includes the processor device 24, the memory 26, and a system bus 68. The system bus 68 provides an interface for system components including, but not limited to, the memory 26 and the processor device 24. The processor device 24 can be any commercially available or proprietary processor.

The system bus 68 may be any of several types of bus structures that may further interconnect to a memory bus (with or without a memory controller), a peripheral bus, and/or a local bus using any of a variety of commercially available bus architectures. The memory 26 may include non-volatile memory 70 (e.g., read-only memory (ROM), erasable programmable read-only memory (EPROM), electrically erasable programmable read-only memory (EEPROM), etc.), and volatile memory 72 (e.g., random-access memory (RAM)). A basic input/output system (BIOS) 74 may be stored in the non-volatile memory 70 and can include the basic routines that help to transfer information between elements within the computing device 22-Y. The volatile memory 72 may also include a high-speed RAM, such as static RAM, for caching data.

The computing device 22-Y may further include or be coupled to a non-transitory computer-readable storage medium such as a storage device 76, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 76 and other drives associated with computer-readable media and computer-usable media may provide non-volatile storage of data, data structures, computer-executable instructions, and the like.

A number of modules can be stored in the storage device 76 and in the volatile memory 72, including an operating system and one or more program modules, such as the scheduler 28, which may implement the functionality described herein in whole or in part. All or a portion of the examples may be implemented as a computer program product 80 stored on a transitory or non-transitory computer-usable or computer-readable storage medium, such as the storage device 76, which includes complex programming instructions, such as complex computer-readable program code, to cause the processor device 24 to carry out the steps described herein. Thus, the computer-readable program code can comprise software instructions for implementing the functionality of the examples described herein when executed on the processor device 24. The processor device 24, in conjunction with the scheduler 28 in the volatile memory 72, may serve as a controller, or control system, for the computing device 22-Y that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 24 through an input device interface 82 that is coupled to the system bus 68 but can be connected by other interfaces such as a parallel port, an Institute of Electrical and Electronic Engineers (IEEE) 1394 serial port, a Universal Serial Bus (USB) port, an IR interface, and the like. The computing device 22-Y may also include a communications interface 84 suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
determining, by a first computing device, that an asynchronous function of an executing process executing on a second computing device is to be invoked;
determining, by the first computing device, that a real-time condition of the second computing device is met;
in response to determining that the real-time condition of the second computing device is met, selecting an execution computing device that is a different computing device than the second computing device; and
causing the asynchronous function to be executed on the execution computing device.

2. The method of claim 1, wherein the execution computing device is the first computing device, and wherein causing the asynchronous function to be executed on the execution computing device comprises invoking, by the first computing device, the asynchronous function.

3. The method of claim 1, wherein the execution computing device comprises a third computing device, and further comprising sending, by the first computing device to the third computing device, instructions to invoke the asynchronous function to cause the asynchronous function to be executed on the third computing device.

4. The method of claim 1, further comprising:
receiving, by the first computing device from the second computing device, information identifying the asynchronous function.

5. The method of claim 1, wherein determining, by the first computing device, that the real-time condition is met comprises:
accessing, by the first computing device, a real-time resource utilization value that quantifies a real-time resource utilization of the second computing device;
determining that that the real-time resource utilization value is a non-preferred value; and
in response to determining that the real-time resource utilization value is the non-preferred value, determining that the real-time condition is met.

6. The method of claim 5, wherein the real-time resource utilization value quantifies a current processor utilization of a processor device of the second computing device.

7. The method of claim 1, wherein determining, by the first computing device, that the real-time condition is met comprises:
determining, by the first computing device, that a battery level of the second computing device is below a predetermined battery level threshold; and
in response to determining that the battery level of the second computing device is below the predetermined battery level threshold, determining that the real-time condition is met.

8. The method of claim 1, wherein the asynchronous function is defined by programming instructions that are part of a same codebase as the executing process on the second computing device.

9. The method of claim 1, wherein the asynchronous function is one of a plurality of functions of the executing process, and wherein a first set of the plurality of functions is identified as being executable on a computing device other than the second computing device and a second set of the plurality of functions is executable only on the second computing device.

10. The method of claim 1, further comprising:
subsequent to causing the asynchronous function to be executed on the execution computing device, determining, by the first computing device, that the asynchronous function is to be invoked again;
determining, by the first computing device, that the real-time condition is not met; and
in response to determining that the real-time condition is not met, causing the asynchronous function to be executed on the second computing device.

11. The method of claim 1, further comprising:
prior to causing the asynchronous function to be executed on the execution computing device, obtaining, by the first computing device from each of a plurality of third computing devices, real-time resource utilization values that quantify real-time resource utilization of the plurality of third computing devices; and
selecting, by the first computing device, a particular third computing device to be the execution computing device based on the real-time resource utilization values.

12. A first computing device, comprising:
a memory; and
one or more processor devices coupled to the memory to:
determine that an asynchronous function of an executing process executing on a second computing device is to be invoked;
determine that a real-time condition of the second computing device is met;
in response to determining that the real-time condition of the second computing device is met, select an execution computing device that is a different computing device than the second computing device; and
cause the asynchronous function to be executed on the execution computing device.

13. The first computing device of claim 12, wherein the execution computing device comprises a third computing device, and wherein the one or more processor devices are further to send, to the third computing device, instructions to invoke the asynchronous function to cause the asynchronous function to be executed on the third computing device.

14. The first computing device of claim 12, wherein to determine that the real-time condition is met, the one or more processor devices are further to:
access a real-time resource utilization value that quantifies a real-time resource utilization of the second computing device;
determine that that the real-time resource utilization value is a non-preferred value; and
in response to determining that the real-time resource utilization value is the non-preferred value, determine that the real-time condition is met.

15. The first computing device of claim 12, wherein the asynchronous function is one of a plurality of functions of the executing process, and wherein a first set of the plurality of functions is identified as being executable on a computing device other than the second computing device and a second set of the plurality of functions is executable only on the second computing device.

16. The first computing device of claim 12, wherein the one or more processor devices are further to:
subsequent to causing the asynchronous function to be executed on the execution computing device, determine that the asynchronous function is to be invoked again;
determine that the real-time condition is not met; and
in response to determining that the real-time condition is not met, cause the asynchronous function to be executed on the second computing device.

17. The first computing device of claim 12, wherein the one or more processor devices are further to:
prior to causing the asynchronous function to be executed on the execution computing device, obtain, from each of a plurality of third computing devices, real-time resource utilization values that quantify real-time resource utilization of the plurality of third computing devices; and
select a particular third computing device to be the execution computing device based on the real-time resource utilization values.

18. A non-transitory computer-readable storage medium that includes executable instructions to cause one or more processor devices of a first computing device to:
determine that an asynchronous function of an executing process executing on a second computing device is to be invoked;
determine that a real-time condition of the second computing device is met;
in response to determining that the real-time condition of the second computing device is met, select an execution computing device that is a different computing device than the second computing device; and
cause the asynchronous function to be executed on the execution computing device.

19. The non-transitory computer-readable storage medium of claim 18, wherein the execution computing device comprises a third computing device, and wherein the instruction are further to cause the one or more processor devices to send, to the third computing device, instructions to invoke the asynchronous function to cause the asynchronous function to be executed on the third computing device.

20. The non-transitory computer-readable storage medium of claim 18, wherein to determine that the real-time condition is met, the instructions are further to cause the one or more processor devices to:
access a real-time resource utilization value that quantifies a real-time resource utilization of the second computing device;
determine that that the real-time resource utilization value is a non-preferred value; and
in response to determining that the real-time resource utilization value is the non-preferred value, determine that the real-time condition is met.
